(19) United States
(12) Patent Application Publication
(10) Pub. No.: US 2013/0105190 A1
(43) Pub. Date: May 2, 2013

(54) MULTILAYER LIGHTNING STRIKE PROTECTION MATERIAL

(71) Applicant: Volodymyr Volodymyrovych Knyazev, Kharkiv (UA)

(72) Inventor: Volodymyr Volodymyrovych Knyazev, Kharkiv (UA)

(21) Appl. No.: 13/657,881

(22) Filed: Oct. 23, 2012

(30) Foreign Application Priority Data
Oct. 26, 2011 (UA) A 2011 12548

(51) Int. Cl. H02G 13/00

(52) U.S. Cl. CPC H02G 13/00
USPC 174/2

(57) ABSTRACT

The invention relates to lightning strike protection means. The invention refers to a multilayer lightning strike protection material.

A multilayer lightning strike protection material is configured adjoinable, at least partially, to an object to be protected and comprises a dielectric layer and an electrically conductive layer, wherein the material comprises a second dielectric layer, the conductive layer being interposed between the dielectric layers and thickness d of at least one dielectric layer is not less than 0.1 mm.

The present invention provides a multilayer lightning strike protection material that, owing to the most optimum arrangement of layers of components having different properties, decreases the probability of a lightning strike to the object to be protected and ensures a high lightning resistance; decreases the possibility of electrical breakdown in the event of lightning strike hit; ensures that an object which is moving in a space can be protected.

The invention relates to lightning strike protection means as well as to means of preventing both living objects and other objects such as automobiles, baby buggies, bicycles etc. from being possibly exposed to a lightning strike. The invention refers to a multilayer lightning strike protection material.

The most widely used meaning in which the term lightning strike protection is regarded is the protection of various buildings as well as property and people, who are in said buildings, from lightning strikes. Both high-temperature lightning channel a contact whereto would result in explosions and fire and electromagnetic field that appears during a thunderstorm are dangerous. Upon striking the ground or a terrestrial object, a lightning current rate of rise may exceed 10¹¹ A/sec producing a fast-changing magnetic field in a nearby area. The electromotive force which is induced by said magnetic field causes damages to various voltage electric circuits but low-voltage lines of microprocessor equipment, control and automation circuits suffer especially severely. A remote effect of the electromagnetic field may cause the explosion of a structure filled with an explosive gas or dust mixture. In order to prevent such negative effects of lightning strikes, the air-termination system lightning of three types are widely used (i) rods; (ii) catenary wires; and (iii) meshed conductors. The use of such air-termination system lightning discharges is governed by the standards IEC 62305-3:2010 “Protection against lightning Part 3: Physical damage to structures and life hazard”. However, a substantial disadvantage of such technology of lightning strike protection is its incapability of providing the protection of a small object, for example, a human being who in turn is moving. There exist methods for protecting objects which are moving in a space from lightning strikes as well as methods for preventing such strikes which comprise the employment of special materials which coat an object to be protected from lightning strikes.

Most often, coatings of such materials comprise metal structural components which results in an increase in the weight of the entire structure, a shorter service life due to corrosion phenomena, and a reduction in manufacturability. Accordingly, there remains the need for the development of lightning strike protection materials which have a structure making it possible to ensure a high lightning resistance, lack of corrosion, a high manufacturability, and a relative simplicity of manufacturing such material.

Most structures which use metal components increase, in fact, the probability of lightning strike to the object concerned. The phenomena which occur at the time of lightning strike such as a sonic shockwave, thermal heating, electromagnetic fields, difference of potential, may be fatal for living organisms and detrimental for electronic equipment. For this reason, when developing any lightning strike protection material, the task to reduce the probability of lightning strike to the object to be protected remains the principal one. A known composite material meant for protection against effects of lightning and described in WO2010079198, comprises a structural portion made of an electrically insulating or low-conductive composite material on the surface of which a metallization layer covered with an electrically insulating protection paint is disposed. The metallization layer includes a layer of a first electrically conductive metal material and at least one more electrically conductive metal material.

The disadvantages of the described solution include the fact that said composite material is neither flexible nor elastic, which ensures good structural properties for making an aircraft skin, but is unsuitable for the protection of a human being; in the event of struck with lightning, the composite material is burnt-through, and this is acceptable for an aircraft, as the main requirement is to avoid fragments from flying away, but is unacceptable for human being protection. Furthermore, recommendations on the use of this composite material do not concern a reduction in the probability of lightning strike to the object being protected but only an increase in the resistance of an object made of this material to the effects of lightning current.

Also known is a lightning strike protection device described in Russian Federation Patent Application No. 2006115459, which comprises an electrically conductive film that coats an electrically conductive surface of the object being protected; a protective film that coats an outer side of the electrically conductive film; an electrically insulating film that is interposed between the electrically conductive film and electrically conductive surface of the object being protected; a central processing unit (CPU) connected electrically to the electrically conductive film. Said CPU includes means of monitoring of lightning strike threat to detect lightning strikes, means of lightning polarity measurement, and lightning information analysis; a high-voltage power supply to transmit charges to the electrically conductive film; and a control unit to control the charge transmission process by the high-voltage power supply.

The disadvantages of the described solution include a relative complexity and awkwardness of structure because of the existence of the CPU and high-voltage power supply that is connected electrically to the electrically conductive film, making it impossible to ensure the mobility of protection from possible lightning strikes, particularly in the event of utilizing such device to protect an individual who is moving in a space. Moreover, the effectiveness of the described solution may only be manifested upon the voltage supply to the film of not less than 100 kV, since the difference of potential between the lightning leader head and the object earthed is generally not less than 10 MV. The use of such high voltages (100 kV) is extremely dangerous for a human being, especially under high humidity conditions occurring during rains. Furthermore, a method for lightning strike protection which employs said device is based on using an “electrical capacity” effect according to claim 1 of the set of claims which states that the electrically conducting film is outside the conductor surface, and the charges thereon have the reverse polarity relative to the charges induced by lightning and the charges on the surface are added to the electrically conducting film It is known, however, that the probability of lightning strike to an object correlates most strongly not only with the total amount of a charge induced at the object but also with electric field strength at the object components.

The most similar to the claimed invention is a multilayer lightning strike protection material which is described in Ukrainian Patent No. 64651 including at least one dielectric layer and at least one electrically conductive layer. The electrically conductive layer is made of a metal knitted mesh fabric made of solder-coated wires. The dielectric layer is disposed over the electrically conductive layer and the dielectric layer is topped with a lacquer coating. Herewith, the wires of adjacent rows form, where they contact, a permanent connection with each other the tearing strength whereof is from 0.1 to 1.0-fold the shearing strength of the solder material.

The disadvantages of the described solution include the fact that the existence of the knitted mesh when placed in an electric field of a thunder cloud and a field generated by a lightning channel results in the occurrence of multiple sources of corona discharges from thin wires of the mesh and as a result the probability of a lightning strike to such object increases. In addition, the lightning strike protection material as described in Ukrainian Patent No. 64651 fails to protect the earthed object located behind it in the event of lightning strike hit.

The basic object of the present invention is to provide a multilayer lightning strike protection material that, owing to the most optimum arrangement of layers of components having different properties, decreases the probability of a lightning strike to the object protected and ensures a high lightning resistance; decreases as much as possible the possibility of electrical breakdown in the event of lightning strike hit; ensures that an object which is moving in a space, in particular, a human being can be protected.

To achieve this object, the present invention provides a multilayer lightning strike protection material which is configured adjoinable, at least partially, to an object to be protected and comprises a dielectric layer and an electrically conductive layer, wherein the material comprises a second dielectric layer the electrically conductive layer being interposed between the dielectric layers and thickness d of at least one dielectric layer is not less than 0.1 mm.

The principal function of said dielectric layers is to ensure insulation, i.e., to intercept the passage of a counter-streamer from the object to a lightning leader and to diminish effects of lightning current. This is ensured by a determined level of pulse electric strength of insulation upon exposure to pulse voltage (for example, with parameters of 1.2/50 μsec). The typical value of breakdown voltage for solid dielectrics is 70 kV for a layer thickness of 1 mm However, through the use of particularly strong both mechanically and electrically materials, it becomes possible to employ at least one dielectric layer of thickness d of not less than 0.1 mm which makes it possible to ensure a sufficient enough safety level of the object to be protected for account of decrease in the probability of a lightning strike to the object to be protected as well as both a high strength and a good operational performance of said dielectric layer. An increase in the thickness of the dielectric layers improves the safety level of the object to be protected provided with the help of the material applied. The configuration of the dielectric layer with thickness d of less than 0.1 mm is disadvantageous as a sufficient enough strength of the said layer and physical and technological properties will not be ensured.

The decrease in the probability of a lightning strike to the object is caused by the following factors. It is known (p. 310, Bazelyan E. M., Raizer Yu. P., Physics of Lightning and Lightning Protection.-Moscow: Physmathlit, 2001.-320 pp.) that the development of a leader from an object is always preceded by a positive streamer. The positive streamer appears when a corona current becomes higher than the limiting current. According to the formula (8) given in the above cited reference, the value of such limiting current decreases as the radius of a corona-forming element reduces. Therefore, the electrically conductive layer placed with a minimally possible curvature provides shielding and the strength equalization of the electric field from elements of the object to be protected which results in slowing down of the development of a counter-streamer (from the object to the lightning leader). This effect is strengthened by the existence of the top dielectric layer which prevents the corona current from rising to the values which result in the development of a streamer flash. Thus, the probability of the connection of this streamer and the descending lightning leader is reduced which makes it possible to decrease the probability of a lightning strike to the object to be protected. In fact, this dielectric layer has the function of a barrier that increases the discharge voltage of the gap between the object to be protected and the lightning leader head.

In accordance with one preferred embodiment of the claimed invention, wherein thickness d of the dielectric layers is from 0.5 mm to 15 mm (the largest preferred gap). Such configuration of said dielectric layers makes it possible to ensure the most optimum protection of the object, in particular, to ensure both decrease in the probability of lightning strike hit and protection against a step voltage that develops in the event of a nearby lightning strike to another object, as well as to mitigate the level of unfavorable consequences of a direct lightning strike.

Also, in the event of a lightning strike hit, the discharge may proceed over the surface of the top dielectric layer, as the breakdown voltage on the surface is significantly lower than the breakdown voltage of the dielectric layer. For the efficient utilization of this property the most preferred thickness of the dielectric layer must be about 0.5 mm. In the event of dielectric layer breakdown, the lightning channel will connect to the electrically conductive layer. The average value of a current in the lightning channel is about 30 kA. If the resistance of the electrically conductive layer to a current flow to the ground does not exceed 1 Ω, no dielectric layer breakdown will occur (30×1=30 kV which is less than the typical dielectric strength of polyethylene of 0.5 mm thick equal to 35 kV).

In accordance with another preferred embodiment of the claimed invention, at least one dielectric layer of the material in accordance with the claimed invention is configured, at least partially, structured and comprises at least two sublayers of a material with a high dielectric strength which makes it possible to ensure good protective properties of the material of the invention and improve the effectiveness of wide adoption thereof.

In accordance with yet another preferred embodiment of the claimed invention, an interlayer space filled with an electrically insulating gas is present between the sublayers of the dielectric layer. The compressed air may be used as electrically insulating gas. This embodiment of the claimed invention makes it possible to improve the electrically insulating properties of the dielectric layer as well as to ensure certain structural properties of the material of the invention for account of filling the interlayer space with air under pressure over 1 atm., which in turn improves the protective properties of the material of the claimed invention as a whole.

Advantageously, the electrically conductive layer is configured structured and comprises at least two sublayers. One (interior) sublayer may be made of a wire mesh (for example, of copper), which has the function of current drainage and of ensuring the tearing strength of the material of the invention; the other (exterior) sublayer, which has the function of an equalizing electrostatic shield, may be made in the form of an electrically conductive elastomer which covers the interior sublayer.

The dielectric layers and the electrically conductive layer may be connected by gluing using an all-purpose adhesive such as, for example, cyanoacrylate.

In accordance with yet another preferred embodiment of the present invention, wherein the electrically conductive layer of the material of the invention is disposed on a backing made of a dielectric material.

A physical substantiation of a decrease in the probability of a direct lightning strike to the object is given above. This is not the only useful property of the material of the invention. Indeed, as known from the prior art (p. 19, Bazelyan E. M., Raizer Yu. P., Physics of Lightning and Lightning Protection.-Moscow: Physmathlit, 2001.-320 pp.), the probability that a lightning strike hits low objects including a human being is very low. The radius of attracting lightning strikes to a human being is not more than 6 meters; the area of attraction is not more than 10⁻⁴ sq. km. Since a lightning density rarely exceeds 10 strikes per square kilometer per year, such hit should be waited for 1000 years. However, Lightning strikes have had much more victims without any involvement of a direct hit. As a rule, people who hide under trees during a thunderstorm become such victims. The probability that a lightning strike hits a tree is 100 times higher than the probability that a lightning strike hits a human being. When standing under a tree crown, a human being has a noticeable chance to find himself/herself within an area of lightning current spreading. A lightning current of 30 kA that flows down along the tree trunk to the ground of 200 Ωm in resistivity develops a step voltage of about 200 kV. This voltage is applied to footwear soles and, following their quick breakdown, to the human body.

### BRIEF DESCRIPTION OF THE DRAWINGS

In the following, the invention will be described in more detail with reference to the accompanying drawings, in which:

FIG. 1 is a general view of an embodiment of the claimed invention; and

FIG. 2 is a general view of an embodiment of a product made of the multilayer lightning strike protection material.

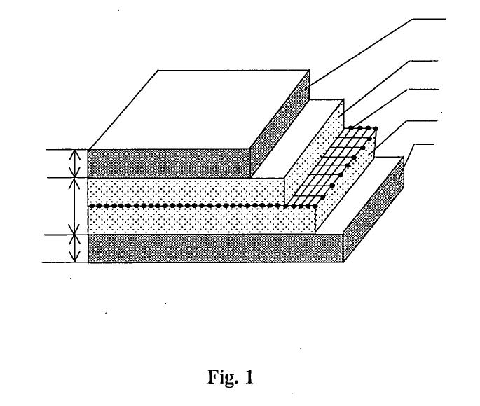

FIG. 1 depicts a multilayer lightning strike protection material which is configured adjoinable, at least partially, to an object to be protected and comprises a dielectric layer 1, an electrically conductive layer 2, and a second dielectric layer 3. The electrically conductive layer 2 is configured structured. One (interior) sublayer may be made of a wire mesh 4 (for example, of copper), which has the function of current drainage and of ensuring the tearing strength of the material of the invention; the other (exterior) sublayer, which has the function of an equalizing electrostatic shield, may be made in the form of an electrically conductive elastomer which covers the interior sublayer.

The implementation of the properties of the multilayer lightning strike protection material in accordance with the present invention is accomplished through its using for manufacturing umbrellas, raincoats, capes, covers, tents and similar products which are used to protect from rain. Advantageously, the product has a shape that covers at least the entire top portion of the object to be protected. Furthermore, in the manufacture of products of the material in accordance with the present invention, there should be followed a simple linear dependence between dielectric layer thickness d and radius of curvature R, namely: d=10−(R−10) 0.01, where: R is the radius of curvature, in mm, within the range from 10 mm to 1000 mm; and d is the thickness of the dielectric layer, in mm. For example, if R=10 mm, then d=10 mm, and if R=1000 mm, then d=0.1 mm. Thus, An increase in the radius of curvature of the product through the employment of various structures with the use of the material in accordance with the present invention will decrease significantly the probability of a direct lightning strike hit to the object.

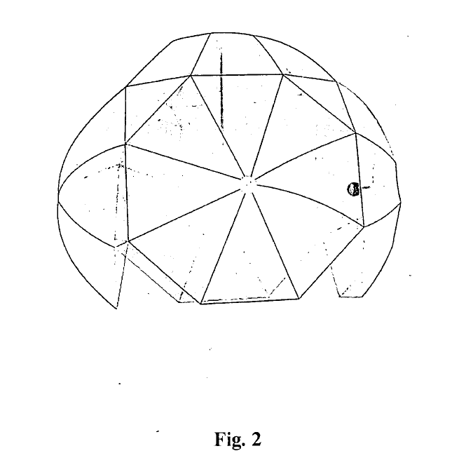

By way of example, FIG. 2 depicts an embodiment of a product made of the multilayer lightning strike protection material in accordance with the present invention, namely, a lightning strike protection umbrella. It should be noted that the structural components of such umbrella are preferably made of dielectric materials, such as, for example, composite epoxy material, bamboo etc.

If necessary the existing interlayer hollow spaces may be filled with air in any convenient way to give more rounded shapes to the product which also contributes to decreasing the probability of a lightning strike hit.

In accordance with a preferred embodiment, the multilayer lightning strike protection material in accordance with the present invention may also be used as a mat to prevent a step-voltage shock.

Thus, the present invention provides a multilayer lightning strike protection material that, owing to the most optimum arrangement of layers of components having different properties, decreases the probability of a lightning strike to the object to be protected and ensures a high lightning resistance; decreases as much as possible the possibility of electrical breakdown in the event of lightning strike hit; ensures that an object which is moving in a space, in particular, a human being can be protected.

1. A multilayer lightning strike protection material which is configured adjoinable, at least partially, to an object to be protected and comprises a dielectric layer and an electrically conductive layer, characterized in that the material comprises a second dielectric layer, the electrically conductive layer being interposed between the dielectric layers and thickness d of at least one dielectric layer is not less than 0.1 mm.

2. The material as claimed in claim 1, characterized in that thickness d of the dielectric layers is from 0.5 mm to 15 mm.

3. The material as claimed in claim 1, characterized in that at least one dielectric layer is configured layered and comprises at least two sublayers of a material with a high dielectric strength.

4. The material as claimed in claim 2, characterized in that an interlayer space is present between the sublayers of the high dielectric strength material, which can be filled with a gas, for example, air.

5. The material as claimed in claim 1, characterized in that the electrically conductive layer is configured layered and comprises at least two sublayers of an electrically conductive material.

6. The material as claimed in any of claims 1 to 5, characterized in that at least one electrically conductive layer of the material is provided with a backing of a dielectric material.
